(19) United States
(12) Patent Application Publication
(10) Pub. No.: US 2025/0387734 A1
(43) Pub. Date: Dec. 25, 2025

(54) UV Mesh Cover for Clarifiers and Systems Thereof

(71) Applicant: Xylem Water Solutions Zelienople LLC, Zelienople, PA (US)

(72) Inventors: Salvador Dominguez Madeira, Charlotte, NC (US); Matthew Sudak, Mars, PA (US)

(21) Appl. No.: 18/570,091

(22) PCT Filed: Jun. 15, 2022
(86) PCT No.: PCT/US22/33564

§ 371 Date: Dec. 14, 2023

Related U.S. Application Data
(60) Provisional application No. 63/210,663, filed on Jun. 15, 2021.

(51) Int. Cl. B01D 21/00; C02F 1/00

(52) U.S. Cl. CPC B01D 21/0003; B01D 21/0045; B01D 21/0069; C02F 1/00; C02F 2001/007; C02F 2201/002

(57) ABSTRACT

A water treatment system for treating water is provided. The water treatment system includes a basin; a pair of clarifiers disposed in the basin; a pair of collection troughs each arranged at least partially above a corresponding one of the pair of clarifiers; and at least one cover assembly comprising: a frame coupled to the pair of collection troughs, and a cover coupled to the frame, the cover being made of a nylon mesh material.

### CROSS-REFERENCE TO RELATED APPLICATION

This application claims the benefit of U.S. Provisional Application No. 63/210,663, dated Jun. 15, 2021, the disclosure of which is hereby incorporated by reference in its entirety.

### BACKGROUND

Large outdoor basins for water, wastewater, and/or process water treatment are exposed to the sun, which can promote algae growth as well as debris or wildlife to fall or nest into the basin. Customers use different types of covers to protect the basin from these. These covers are typically made from metal or fiberglass plates which are very costly and are heavy to open and increases time for inspections and maintenance of the system. Another challenge is that in the case of heavy rain falls, these areas don't allow water to pass and can create floods in the plant. Metal grate solutions try to address the challenge of weight and water pass but do not protect from UV and still allow algae to grow which causes performance and water quality issues and ultimately cost for service and maintenance.

### SUMMARY OF THE INVENTION

In one aspect of the present disclosure, a water treatment system includes: a basin; a clarifier disposed in the basin; a pair of collection troughs each arranged at least partially above the clarifier; and at least one cover assembly including: a frame coupled to the pair of collection troughs, and a cover coupled to the frame, the cover being made of a nylon mesh material.

The frame may be pivotably coupled to the pair of collection troughs and may be configured to pivot between an open position and a closed position. The frame may include a rectangular-shaped body portion and a pair of flanges, each of the pair of flanges extending outwardly from an opposing side of the body portion and being configured to rest on and engage a corresponding one of the pair of collection troughs. The cover may weigh less than 14 pounds. The cover may include a logo on a surface of the cover. The at least one cover assembly may be a plurality of cover assemblies. The clarifier may include a plurality of planar inclined sheets including a flexible polymeric material. The flexible polymeric material may include polyester, polyethylene, polypropylene, polytetrafluoroethylene (PTFE), and/or polyvinyl chloride (PVC). The clarifier may include a plurality of vertically-oriented supports, wherein a sheet of the plurality of planar inclined sheets is tensioned between the plurality of vertically-oriented supports. A vertically-oriented support of the plurality of vertically-oriented supports may include an inlet opening configured to allow liquid to flow therethrough. The plurality of planar inclined sheets may be arranged parallel to one another, and each sheet of the plurality of planar inclined sheets may be tensioned between a plurality of vertically-oriented supports. Vertically-oriented supports tensioning a first sheet of the plurality of planar inclined sheets may interlock with adjacent vertically-oriented supports tensioning a second sheet of the plurality of planar inclined sheets. The water treatment system may further include a pair of buoyant members that are configured to support each collection trough of the pair of collection troughs.

In another aspect of the present disclosure, a method for treating water includes: providing the above-described water treatment system; flowing water to the clarifier; and collecting clarified water and/or waste material separated from the water by the clarifier.

The present invention further includes the subject matter of the following clauses.

Clause 1: A water treatment system comprising: a basin; a clarifier disposed in the basin; a pair of collection troughs each arranged at least partially above the clarifier; and at least one cover assembly comprising: a frame coupled to the pair of collection troughs, and a cover coupled to the frame, the cover being made of a nylon mesh material.

Clause 2: The water treatment system according to clause 1, wherein the frame is pivotably coupled to the pair of collection troughs and is configured to pivot between an open position and a closed position.

Clause 3: The water treatment system according to clause 1 or clause 2, wherein the frame comprises a rectangular-shaped body portion and a pair of flanges, each of the pair of flanges extending outwardly from an opposing side of the body portion and being configured to rest on and engage a corresponding one of the pair of collection troughs.

Clause 4: The water treatment system according to any one of clauses 1-3, wherein the cover weighs less than 14 pounds.

Clause 5: The water treatment system according to any one of clauses 1-4, wherein the cover comprises a logo on a surface of the cover.

Clause 6: The water treatment system according to any one of clauses 1-5, wherein the at least one cover assembly is a plurality of cover assemblies.

Clause 7: The waste treatment system according to any one of clauses 1-6, wherein the clarifier comprises a plurality of planar inclined sheets comprising a flexible polymeric material.

Clause 8: The water treatment system according to clause 7, wherein the flexible polymeric material comprises polyester, polyethylene, polypropylene, polytetrafluoroethylene (PTFE), and/or polyvinyl chloride (PVC).

Clause 9: The water treatment system according to clause 7 or clause 8, wherein the clarifier comprises a plurality of vertically-oriented supports, wherein a sheet of the plurality of planar inclined sheets is tensioned between the plurality of vertically-oriented supports.

Clause 10: The water treatment system according to clause 9, wherein a vertically-oriented support of the plurality of vertically-oriented supports comprises an inlet opening configured to allow liquid to flow therethrough.

Clause 11: The water treatment system according to any one of clauses 7-10, wherein the plurality of planar inclined sheets are arranged parallel to one another, and each sheet of the plurality of planar inclined sheets is tensioned between a plurality of vertically-oriented supports.

Clause 12: The water treatment system according to clause 11, wherein vertically-oriented supports tensioning a first sheet of the plurality of planar inclined sheets interlock with adjacent vertically-oriented supports tensioning a second sheet of the plurality of planar inclined sheets.

Clause 13: The water treatment system according to any one of clauses 1-12, further comprising a pair of buoyant members that are configured to support each collection trough of the pair of collection troughs.

Clause 14: A method for treating water, comprising: providing the water treatment system according to any one of clauses 1-13; flowing water to the clarifier; and collecting clarified water and/or waste material separated from the water by the clarifier.

### BRIEF DESCRIPTION OF THE DRAWINGS

FIG. 1 is a perspective view of a water treatment system according to one aspect of the present invention;

FIG. 2 is a front view of a cover assembly of a water treatment system in an open position according to another aspect of the present invention;

FIG. 3 is a front view of a cover assembly of a water treatment system in an open position according to another aspect of the present invention;

FIG. 4 is a side view of a cover assembly of a water treatment system in an open position according to another aspect of the present invention;

FIG. 5 is a perspective view of a cover assembly of a water treatment system in an open position according to another aspect of the present invention;

FIG. 6 is a front view of a cover assembly of a water treatment system in a closed position according to another aspect of the present invention;

FIG. 7 is a front view of a cover assembly of a water treatment system in a closed position according to another aspect of the present invention;

FIG. 8 is a perspective view of a cover with a logo according to another aspect of the preset invention;

FIG. 9 is a perspective view of a cover according to another aspect of the present invention;

FIG. 10 is a perspective view of a module of a clarifier according to another aspect of the present invention;

FIG. 11 is a perspective view of two interlocked modules of a clarifier according to another aspect of the present invention;

FIG. 12 is a perspective view of a module including a plurality of planar inclined sheets according to another aspect of the present invention;

FIG. 13 is a perspective view of a water treatment system;

FIG. 14 is a side view of the water treatment system of FIG. 13;

FIG. 15 is a front view of the water treatment system of FIG. 14;

FIG. 16 is a perspective view of the clarifier of FIG. 13 not positioned in a basin;

FIG. 17 is a perspective view of a water treatment system having a clarifier supported using upper cables according to another aspect of the present invention;

FIG. 18 is a perspective view of a water collection system utilizing buoyant members;

FIG. 19 is a perspective view of a water treatment system including the water collection system of FIG. 18;

FIG. 20 is a perspective view of another embodiment of a water treatment system according to another aspect of the present invention;

FIG. 21 is a close-up perspective view of the modules of the water treatment system of FIG. 20 welded together;

FIG. 22 is a perspective view of another embodiment of a water treatment system having a tube clarifier; and

FIG. 23 is a perspective view of the tube clarifier of FIG. 22 supported by a frame.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

All numbers used in the specification and claims are to be understood as being modified in all instances by the term “about.” The terms “approximately,” “about,” and “substantially” mean a range of plus or minus ten percent of the stated value.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

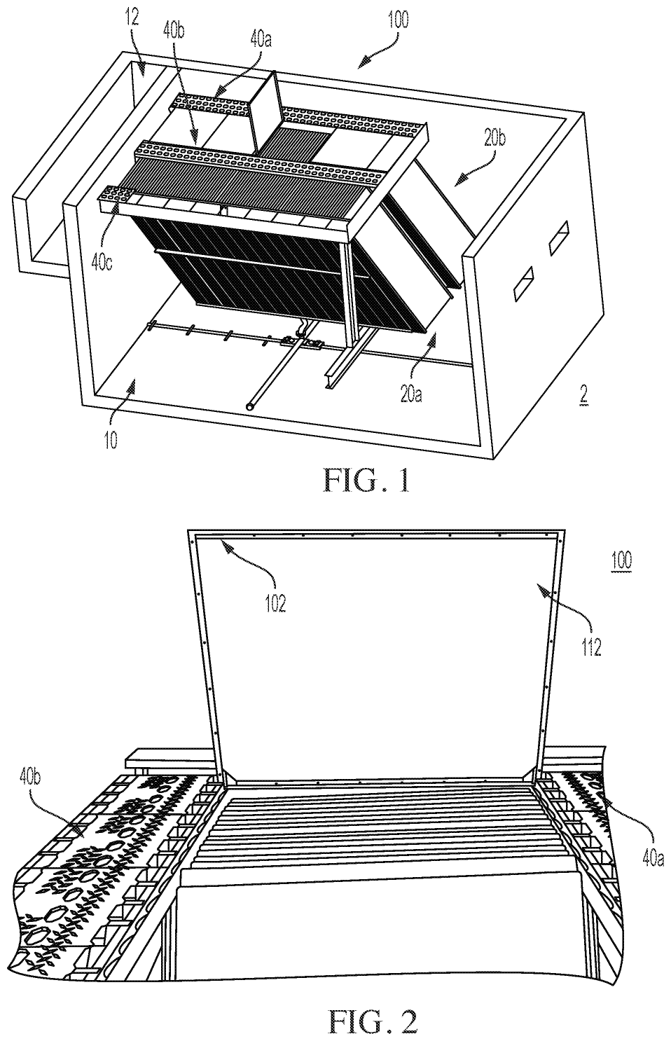

FIG. 1 is a perspective view of a portion of a water treatment system 2, in accordance with one non-limiting embodiment of the disclosed concept. The water treatment system 2 includes a basin 10 defined by a plurality of walls and a floor. The water treatment system 2 includes at least one clarifier 20a, 20b positioned in the basin 10. The clarifier 20a, 20b may further include a collection system including a collection trough 40a, 40b, 40c arranged at least partially above the clarifier 20a, 20b. The collection trough 40a, 40b, 40c may be configured to receive clarified water flowing trough the clarifier 20a, 20b, such as the water flowing out the top of the clarifier 20a, 20b, which has been clarified by gravity causing the waste materials from the process water flowed to the clarifier 20a, 20b being settled to the bottom. The basin 10 may include an effluent channel 12, into which clarified water treated by the water treatment system 2 is flowed. In some non-limiting examples, the clarified water may flow from the collection trough 40a, 40b, 40c into the effluent channel 12.

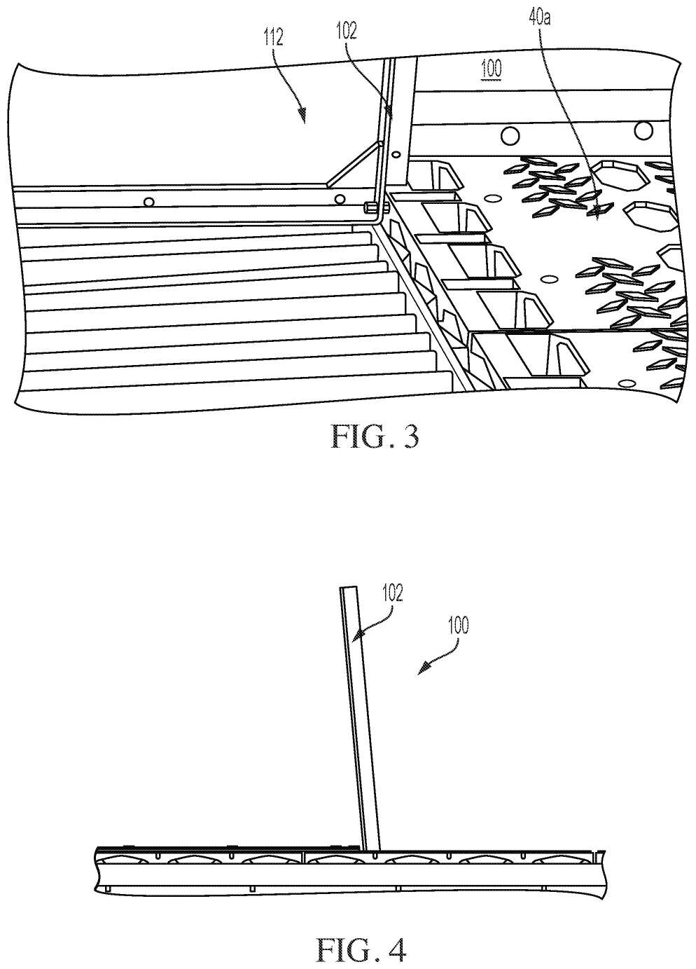

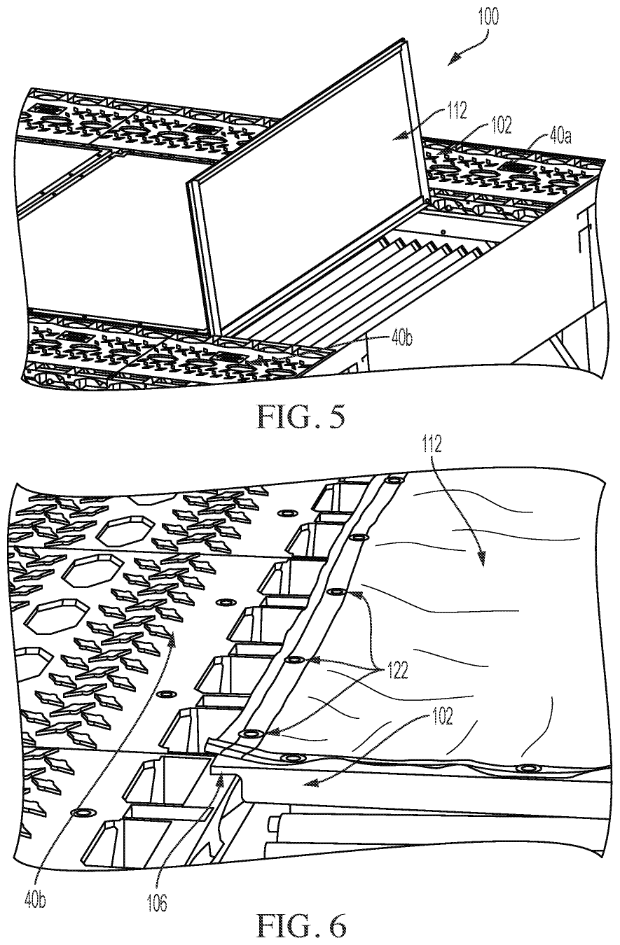

In accordance with the disclosed concept, the water treatment system 2 further includes a number of improved cover assemblies (one cover assembly 100 is indicated in FIG. 1, see also FIGS. 2-5). It will be appreciated that between each of the collection troughs 40a and 40b, and 40b and 40c, there may be a plurality of cover assemblies in order to allow operators to perform inspections at many different locations within the system 2. Referring to FIG. 2, the cover assembly 100 includes a frame 102 and a cover 112 coupled to the frame 102. In one example embodiment, the frame 102 is rectangular-shaped (e.g., without limitation, square-shaped). The frame 102 is preferably made of metal, but other suitable materials are contemplated herein. The frame 102 may include four or more elongated pre-formed members that are connected together via fasteners or welded to be rectangular-shaped. The frame may also be formed of a single piece of metal that is bent into shape and connected at its ends to be rectangular-shaped.

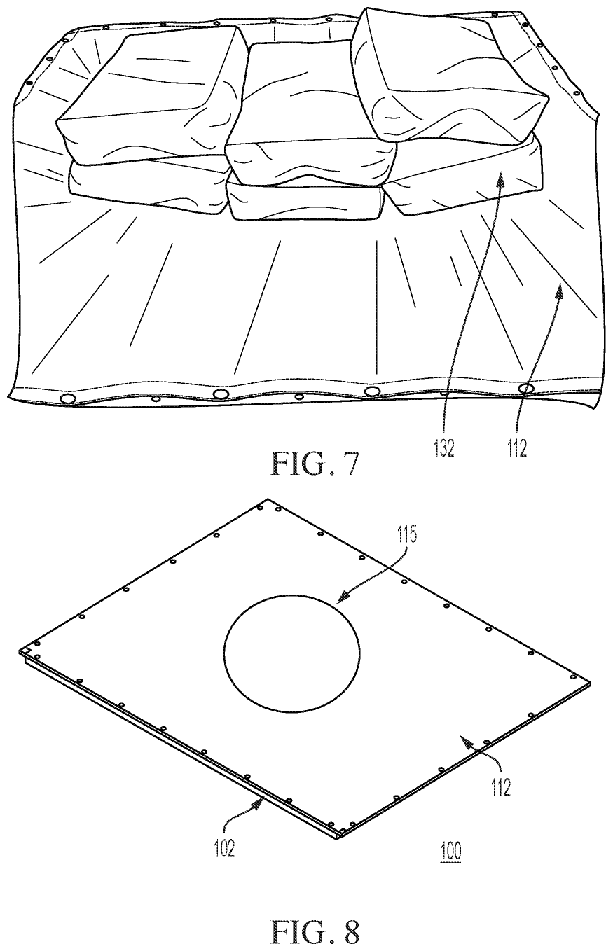

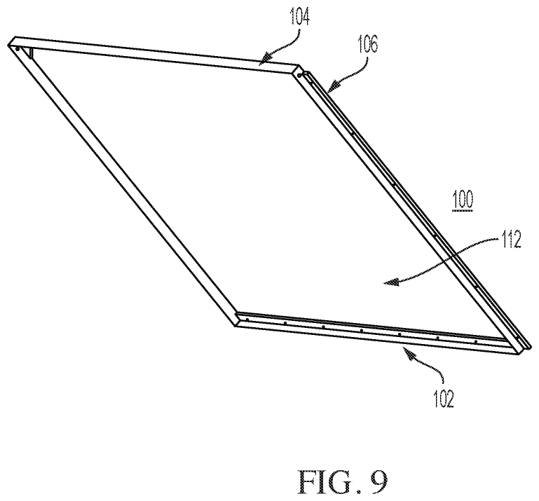

Additionally, the cover 112 may be coupled to the frame 102 via fasteners 122, as shown in FIG. 6. The fasteners 122 may be, for example and without limitation, binding barrels and screws (e.g., steel binding barrels and screws). The fasteners 122 may optionally be evenly spaced along the frame 102. It will be appreciated that the cover assembly 100 is configured to pivot between an open position (FIGS. 1-5) and a closed position (FIGS. 6-7). In order to pivot between positions, the frame 102 is preferably pivotably coupled to the collection troughs 40a, 40b. Furthermore, when the cover assembly 100 is in the closed position (FIGS. 6-7), the frame 102 rests on and engages the collection troughs 40a, 40b via flanges 106, (see FIG. 6 and FIG. 9), discussed below. In this manner, the cover assembly 100 is provided with a substantial amount of support from the collection troughs 40a, 40b. This is advantageous because in the event that an operator, who is performing an inspection on the water treatment system 2, slips and falls onto the cover 112, there is a relatively low likelihood that the operator will fall into the basin 10. More specifically, the frame 102 and the cover 112 are configured to support up to about 300 pounds. See, for example, FIG. 7, which shows a weight 132 supported on the cover 112.

The cover 112 may include a plastic mesh or a plastic geotextile, such as a nylon mesh material, which allows water to pass (˜84 Imp/m² or 120 gpm/ft²), but at the same time blocks up to about 90% of the UV reducing or eliminating algae growth. The cover assembly 100 further works in a way as a safety net which prevents debris and wildlife from entering the open channel. In one example embodiment, the cover 112 is about five feet by four feet by 1.25 inches. Additionally, the cover 112 is also relatively lightweight, e.g., less than 14 pounds, making inspections relatively easy for operators to perform in that operators can open and close the cover assembly 100 without exerting significant energy at all. Known similar sized metal or fiberglass covers, by way of contrast, typically weigh at least 142 pounds, and as such, typically require at least two operators to manipulate during an inspection.

In accordance with the disclosed concept, this amounts to at least a 70% percent weight reduction, preferably at least an 85% weight reduction, and more preferably at least a 90% weight reduction, compared to a metal or fiberglass cover known in the art. This, and the fact that the frame is designed in a way that it can carry its own body weight when installed next to another frame and anchor against it, advantageously allows one single operator to relatively easily open the cover assembly 100 to perform an inspection on the water treatment system 2. Conventional covers of systems, as stated, require a minimum of two operators in order to remove the large metal or fiberglass covers.

Moreover, the cover 112 can be used to display large advertisements or logos (e.g., without limitation, logo 115 shown in FIG. 8) to be shot from the sky, which is typically a relatively limited option with open surfaces in a treatment plant. It will be appreciated that it is significantly less expensive to print different colors or a logo onto the cover 112, as compared to metal or fiberglass options, thereby allowing for great areal advertisements of the owner of the basin 10.

FIGS. 8 and 9 show different views of the cover assembly 100. As shown more clearly in FIG. 9, the frame 102 has a rectangular-shaped body portion 104, and a pair of flanges (only one flange 106 is shown in FIG. 9) each extending outwardly from an opposing side of the body portion 104 of the frame 102 and being configured to rest on and engage a corresponding one of the collection troughs 40a, 40b when the cover assembly 100 is in the closed position.

The cover assembly 100 and/or cover 112 described herein may be implemented in combination with a clarifier and/or water treatment system. For example the cover assembly 100 and/or cover 112 may be implemented with any clarifier and/or water treatment system known in the art. In some non-limiting embodiments, the cover assembly 100 and/or cover 112 described herein may be implemented in combination with the clarifier and/or water treatment system described in U.S. Pat. No. 10,689,273, the disclosure of which is hereby incorporated by reference in its entirety.

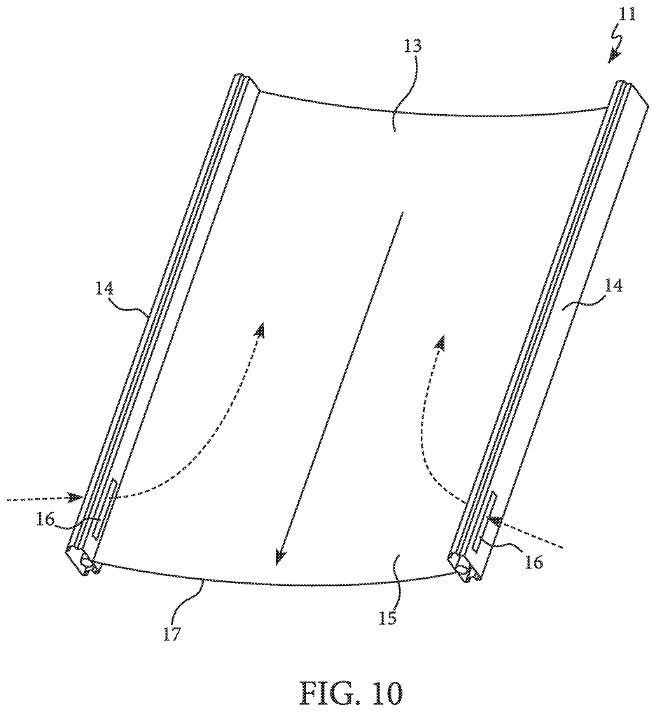

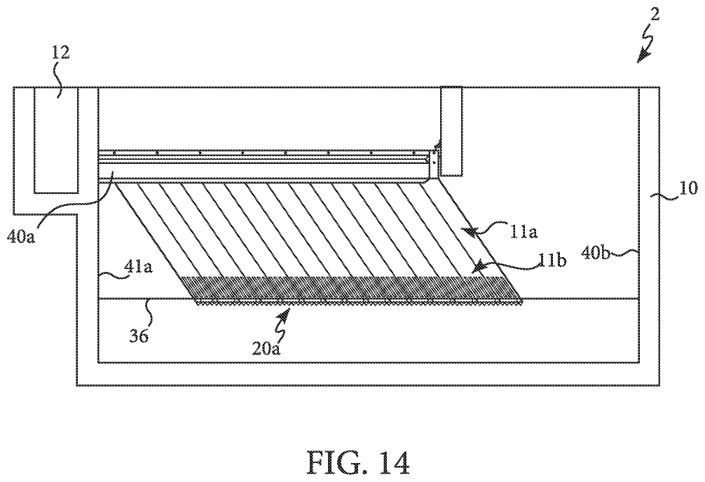

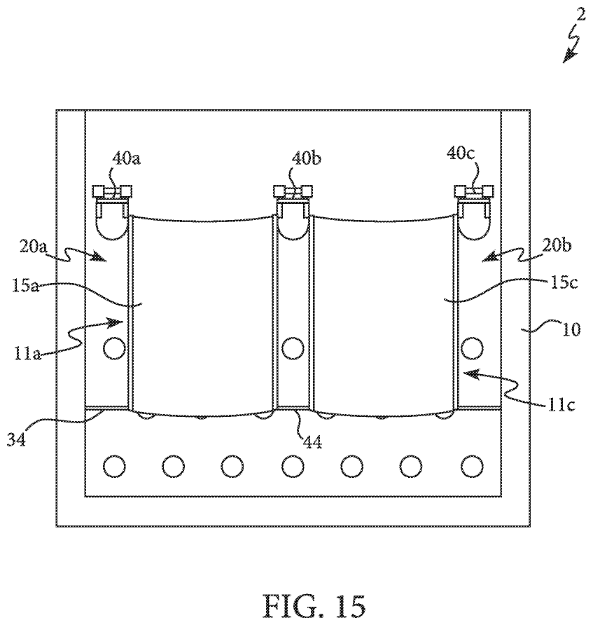

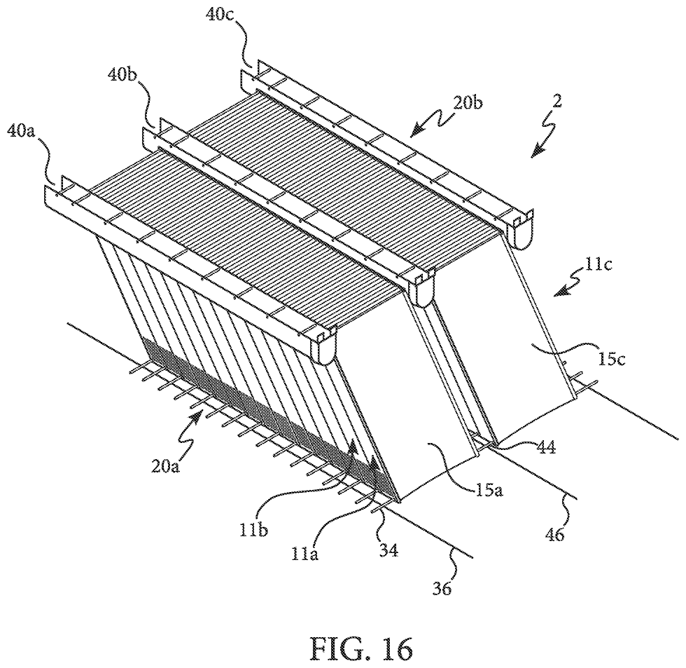

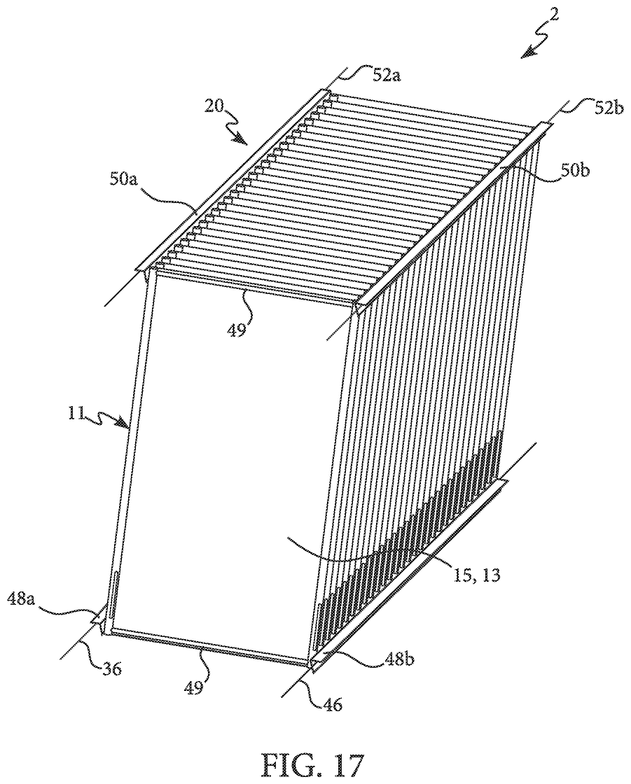

Referring to FIGS. 10-23, the clarifier(s) s 20 and/or the water treatment systems 2 shown in FIGS. 1-9 are provided in further detail. A cover assembly 100 as described herein is not shown in FIGS. 10-23 for clarity purposes. However, a cover assembly 100 as described herein can be included in any of the clarifiers 20 and/or water treatment systems 2 of FIGS. 10-23 in the same manner as described herein for FIGS. 1-9.

Referring to FIG. 10, a module 11 for use in a clarifier for water treatment according to a non-limiting embodiment is shown. The module 11 includes a sheet 15 that may have a hydrophobic surface 13, the sheet 15 including a flexible polymeric material. The sheet may be substantially planar. In some non-limiting embodiments, the flexible polymeric material may be a hydrophobic material. As used herein, the term “hydrophobic material” or “hydrophobic surface” refers to a material or surface which exhibits a Water Contact Angle (WCA) of at least 90° when contacted with water. In some non-limiting examples, the flexible polymeric material includes a fabric treated with a hydrophobic material to form the hydrophobic surface 13. Examples of hydrophobic material includes a silica gel, PTFE, graphite, and/or graphene. The flexible polymeric material may include polyester, polyethylene (e.g., high density polyethylene (HDPE), low density polyethylene (LDPE), linear low density polyethylene (LLDPE)), polypropylene, polytetrafluoroethylene (PTFE), polyvinyl chloride (PVC), or some combination thereof.

With continued reference to FIG. 10, the module 11 may include a plurality of vertically-oriented supports 14. The vertically-oriented supports 14 may be arranged non-parallel with the ground and may form an angle with the ground of from 10° to 90°, such as from 20° to 80°, from 35° to 70°, from 40° to 60°, from 45° to 65°, or from 45° to 55°, so as to be inclined. The angle formed by the vertically-oriented supports 14 relative to the ground may be varied. The angle may be varied using any suitable system, including using the cables used to support the clarifier described hereinafter. At least one of the sheets 15 may be tensioned between the vertically-oriented supports 14. The sheet 15 tensioned between the vertically-oriented supports 14 may form the same angle relative to the ground as the vertically-oriented supports 14. The sheet 15 may be tensioned between the vertically-oriented supports 14 so as to be taut therebetween, or the sheet may be tensioned between the vertically-oriented supports such that the sheet 15 includes some sag. Because the supports are vertically-oriented supports 14 (as opposed to supports arranged parallel to the ground), any sag in the sheet may cause gravity to force waste materials (solids) to the center and bottom of the module 11, as opposed to the waste materials settling toward the center of the sheet 15 at some point higher than the bottom of the sheet 12. This is because the sag helps concentrate the accumulated solids to the center of the sheet 12, similar to a chute. This also helps separate the influent from the waste stream to improve overall clarification by not disturbing the waste stream with the influent water. Thus, the sheet 15 tensioned between the vertically-oriented supports 14 is arranged so as to form the inclined module 11 having an inclined sheet 15.

With continued reference to FIG. 10, at least one of the vertically-oriented supports 14 may include an inlet opening 16 configured to allow liquid to flow therethrough. The dashed arrows and solid arrow show the flow of water and waste materials in the non-limiting embodiment of the module 11 shown. Water enters the module 11 through the inlet openings 16 of the vertically-oriented supports as shown by the dashed arrows. As the water moves up the inclined sheet 15, it is clarified by the waste materials (e.g., sludge) contained in the water flowed to the module 11 settling to the bottom of the module 11 at the base 17 of the clarifier. The flow of waste materials settling at the base 17 is shown by the solid arrow.

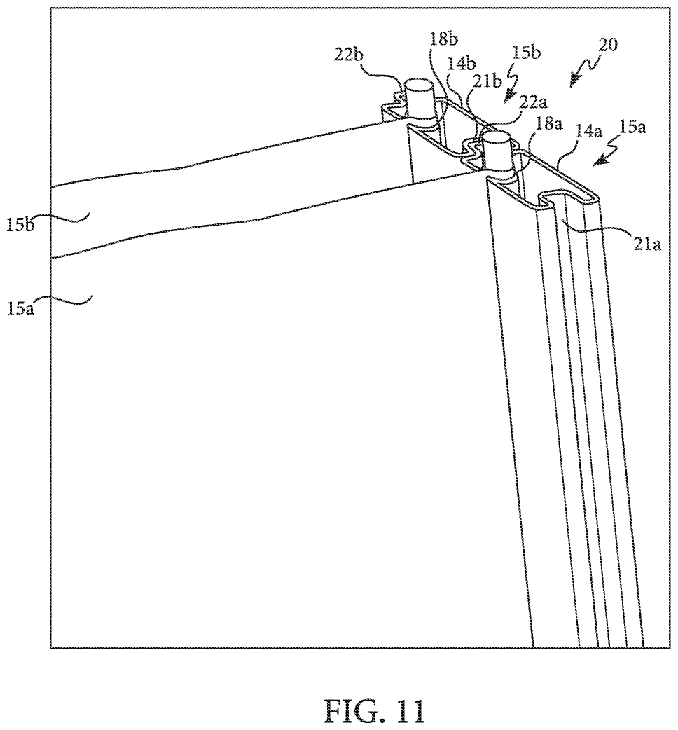

Referring to FIG. 11, a clarifier 20 is shown according to one non-limiting embodiment. The clarifier 20 may include a plurality of planar inclined sheets 15a, 15b. The clarifier 20 includes at least one module 11a, 11b, and in the example shown in FIG. 11, includes two modules 11a, 11b. It will be appreciated that any number of modules 11a, 11b may be used in the clarifier 20. The plurality of sheets 15a, 15b may be arranged in the clarifier 20 parallel to one another, with each sheet 15a, 15b tensioned between a plurality of vertically-oriented supports 14 (they may be the same or different vertically-oriented supports 14). The modules 11a, 11b may also be arranged in the clarifier 20 parallel to one another.

With continued reference to FIG. 11, a non-limiting embodiment of the vertically-oriented supports 14a, 14b is shown. The vertically-oriented supports 14a, 14b may include a recess 18a, 18b to receive the sheet 15a, 15b, such that the sheet 15a, 15b can be tensioned between the vertically-oriented supports 14a, 14b. The sheet 15a, 15b may be fitted over a rod, which is inserted into the recess 18a, 18b, such that the sheet 15a, 15b can be tensioned between the vertically-oriented supports 14a, 14b.

With continued reference to FIG. 11, the modules 11a, 11b of the clarifier 20 may interlock with one another. In one non-limiting embodiment, a first module 11a may interlock with a second adjacent module 11b by the vertically-oriented supports 14a of the first module 11a interlocking with the vertically-oriented supports 14b of the second module 11b. The vertically-oriented supports 14a, 14b may include a first side including a groove 21a, 21b and a second side including a tongue 22a, 22b. The vertically-oriented supports 14a, 14b may interlock with one another by the groove 21b of the first vertically-oriented support 14a engaging the tongue 22a of the second vertically-oriented support 14b.

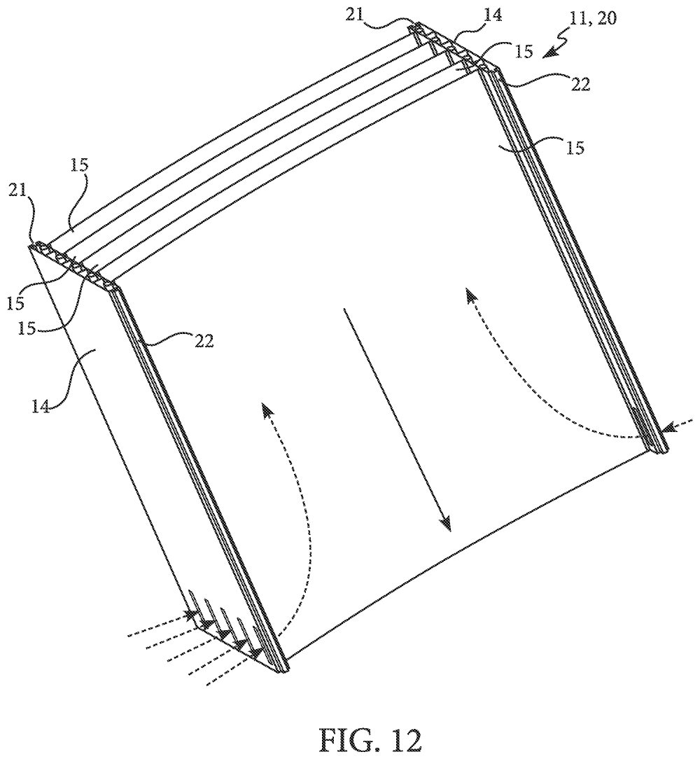

Referring to FIG. 12, another non-limiting embodiment of a clarifier 20 is shown, which include the module 11. The module 11 shown in FIG. 12 includes the vertically-oriented supports 14 as previously described. The vertically-oriented supports 14 include the tongue 22 and groove 21 as previously described. In this non-limiting embodiment, the vertically-oriented supports 14 tension a plurality of sheets 15 therebetween. Five sheets 15 are tensioned between the vertically-oriented supports 14 in this particular embodiment, but it will be appreciated that any number of sheets 15 may be tensioned between vertically-oriented supports 14 of any single module 11.

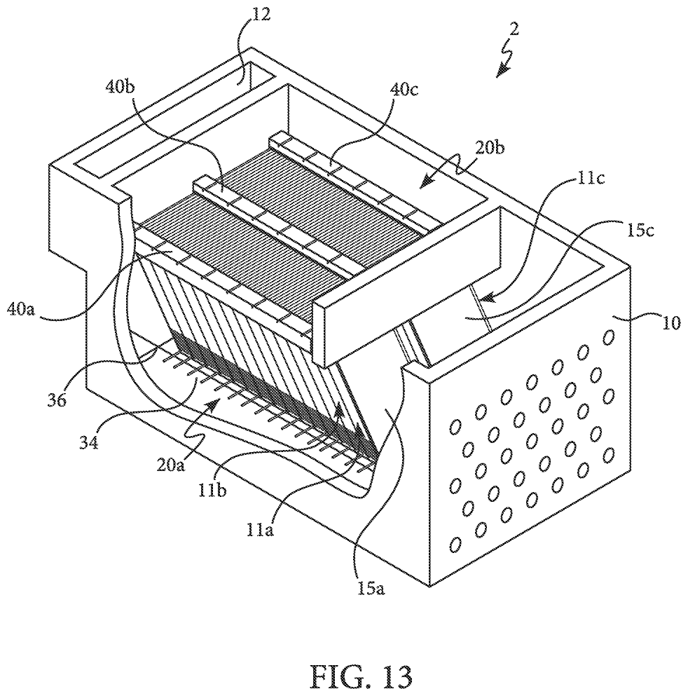

Referring to FIGS. 13-16, a water treatment system 2 is shown according to a non-limiting embodiment. The water treatment system 2 includes a basin 10 defined by a plurality of walls and a floor. The water treatment system 2 includes at least one clarifier 20a, 20b positioned in the basin 10. The water treatment system 2 of FIGS. 13-16 may include the cover assembly 100 of FIGS. 1-9.

With continued reference to FIGS. 13-16, the clarifier 20a, 20b may be supported in the basin 10 using any suitable arrangement. In one such non-limiting arrangement, each module 11a, 11b includes at least one rod 34 which extends proximate a lower section of the module 11a, 11b. A lower cable 36 may engage each of the rods 34, and the ends of the lower cable 36 may be fastened to a wall 41a, 41b of the basin 10, such that the wall 41a, 41b of the basin 10 provides support to the clarifier 20a, 20b.

Clarifiers 20a, 20b may be arranged side-by-side as shown in FIGS. 13-16 (e.g., module 11a of the first clarifier 20a is arranged side-by-side with module 11c of the second clarifier 20b). A center rod 44 may extend between side-by-side clarifiers 20a, 20b to fix the side-by-side clarifiers 20a, 20b relative to one another. The center rods 44 may extend from each module 11a, 11c of the clarifier 20a, 20b, proximate a lower section of the modules 11a, 11c. A center cable 46 may engage the center rods 44 and the ends of the center cable 46 may be fastened to the wall of the basin 41a, 41b as previously described. The rods 34 and the center rods 44 may engage the lower cable 36 and/or the center cable 46 to act as a rigid support for the cables 36, 46, which span a relatively long distance between their ends. The rods 34 may also function to increase or decrease tension on the sheets 15, so as to increase or decrease the curvature of the sheets 15.

With continued reference to FIGS. 13-16, the clarifier 20a, 20b may further include a collection system including a collection trough 40a, 40b, 40c arranged at least partially above the clarifier 20a, 20b. The collection trough 40a, 40b, 40c may be configured to receive clarified water flowing through the clarifier 20a, 20b, such as the water flowing out the top of the clarifier 20a, 20b, which has been clarified by gravity causing the waste materials from the waste water flowed to the clarifier 20a, 20b being settled to the bottom.

With continued reference to FIGS. 13-16, the basin 10 may include an effluent channel 12, into which clarified water treated by the water treatment system 2 is flowed. In some non-limiting examples, the clarified water may flow from the collection trough 40a, 40b, 40c into the effluent channel 12.

Referring to FIG. 17, another water treatment system 2 is shown according to a non-limiting embodiment. The water treatment system of FIG. 17 may include the cover assembly 100 of FIGS. 1-9. In this non-limiting embodiment, a lower track 48a, 48b may be used instead of the previously-described configuration using rods to engage the lower cable 36 and the center cable 46. The lower track 48a, 48b may be positioned proximate the bottom of the sheet 15. The lower track 48a, 48b may engage the lower cable 36 and/or the center cable 46 to act as a rigid support for the cables 36, 46, which span a relatively long distance between their ends.

With continued reference to FIG. 17, spacer bars 49 may be further included to span horizontally (parallel to the ground) across the sheet 15 of the module 11. The spacer bars 49 may be arranged proximate the top and/or the bottom of the sheet 15, as shown in FIG. 17. The spacer bars 49 may be adjustable in length so that the width between sides of the sheet may be adjusted, thereby achieving the desired curvature (sag) of the sheet 15, if any curvature is desired.

With continued reference to FIG. 17, upper tracks 50a, 50b and upper cables 52a, 52b may also be used as further support for the clarifier 20. The upper track 50a, 50b may be positioned proximate the top of the sheet 15 and may engage the upper cables 52a, 52b to act as a rigid support for the upper cables 52a, 52b, which span a relatively long distance between their ends.

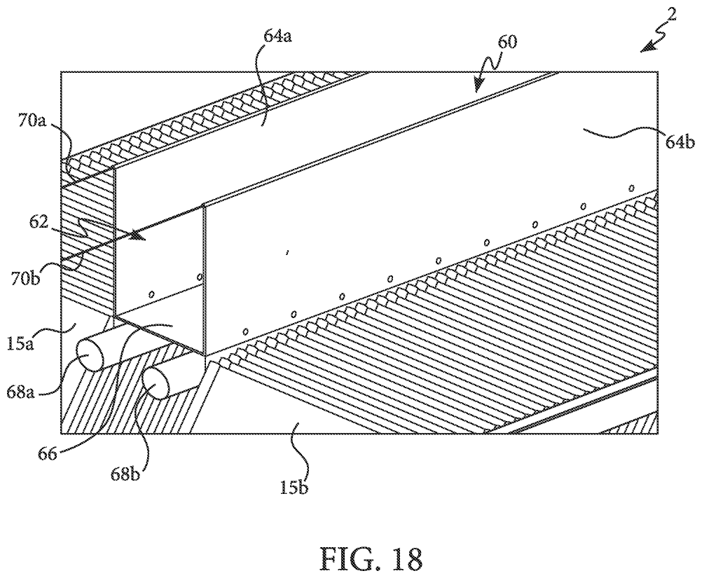

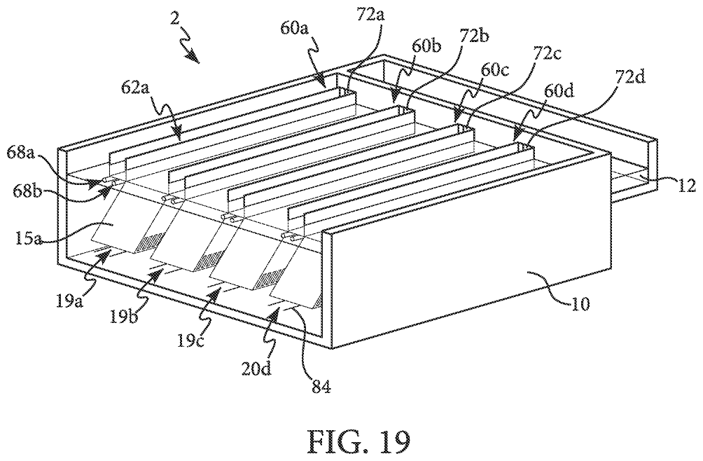

Referring to FIG. 18, a water collection system 60 of a water treatment system 2 is shown. The water collection system 60 includes a buoyant collection trough 62 configured to receive a liquid, such as clarified water from the top of the clarifier. The collection trough 62 may include a plurality of trough walls 64a, 64b connected by a trough base 66. The trough walls 64a, 64b, and the trough base 66 may include a plastic sheet and/or a flexible material, and the trough walls 64a, 64b and the trough base 66 may be made of polyester, polyethylene (e.g., high density polyethylene (HDPE), low density polyethylene (LDPE), linear low density polyethylene (LLDPE)), polypropylene, polytetrafluoroethylene (PTFE), polyvinyl chloride (PVC), or some combination thereof. The trough walls 64a, 64b, and the trough base 66 may include a light weight material. At least one trough cable 70a, 70b may be used to support the trough walls 64a, 64b, and the ends of the trough cables 70a, 70b may be fastened to the basin walls, such that the basin walls support the trough walls 64a, 64b.

With continued reference to FIG. 18, the water collection system 60 may further include a buoyant member 68a, 68b configured to support the collection trough 62. In one non-limiting example, the buoyant members 68a, 68b may include an inflatable bag(s) configured to receive gas and to float in water in the basin 10 and flowed through the clarifier so as to support the collection trough 62. The buoyant members 68a, 68b may include a pontoon having a plastic tube filled with water and/or air such that the buoyant members 68a, 68b float to support the collection trough 62. In some examples, the trough base 66 may be a buoyant member 68a. The buoyant members 68a, 68b may co-act with the trough base 66 and may support and level the trough base 66 (and thus the collection trough 62) and the clarifiers to keep them from sagging with the catenary of the cables 70a, 70b. The buoyant members 68a, 68b may be positioned below the collection trough 62.

Referring to FIG. 19, a water treatment system 2 according to one non-limiting embodiment is shown. The water treatment system 2 of FIG. 19 may include the cover assembly 100 of FIGS. 1-9. The water treatment system includes the basin 10, a clarifier 20a, 20b, 20c, 20d (four in this particular example) positioned in the basin 10, and a water collection system 60a, 60b, 60c, 60d positioned at least partially above each of the clarifiers 20a, 20b, 20c, 20d. The water collection systems 60a, 60b, 60c, 60d are in fluid communication with each of the respective clarifiers 20a, 20b, 20c, 20d. The water treatment system 2 may further include an effluent outlet 72a, 72b, 72c, 72d defined in a wall of the basin 10 between each of the water collection systems 60a, 60b, 60c, 60d (such as collection trough 62a) and the effluent channel 12.

With continued reference to FIG. 19, a method for treating water may include providing a water treatment system 2 including a clarifier 20 as described herein. Water may be flowed into the basin 10 and may flow to the clarifier 20. Waste material from the water may settle to the bottom of the clarifier 20 by gravity forcing the waste material to flow down the hydrophobic surface 13 of the inclined sheet 15, while the clarified water (having less waste materials therein compared to the initial water) continues to flow up the inclined sheet 15 and into the water collection system 60. The clarified water may be collected in the collection trough 62 of the water collection system 60. Thus, the method includes collecting clarified water and/or waste materials that have been separated by the clarifier 20 from the initial water.

With continued reference to FIG. 19, the water treatment system 2 may further include a sparging system 84 positioned in the basin 10. The sparging system 84 may be positioned on the bottom of the basin 10. The sparging system 84 may include air lines running along beneath and along the length of the clarifiers 20a-20d, which include small orifices to bubble air to the clarifiers for cleaning. The sparging system 84 may flow air or other inert gas into the water to encourage removal of sediment from the surface of the sheets 15a. The air may remove sediment from the surface of the sheets 15a by agitating the sheets 15a (exerting a force thereon) to loosen any accumulation of sediment forming on the surface of the sheet 15a. Since the sheets 15a are made of the flexible polymeric material, the air bubbles formed from beneath the sheets 15a may exert a force against the underside of the sheets 15 so that they move to loosen the accumulation thereon. The sheets 15a may be agitated to encourage removal of the sediment using other potential arrangements. For example, the water flow to the basin 15 may be pulsed to agitate the sheets 15a. In another example, the cables of the water treatment system 2 may be moved to agitate the sheets 15a.

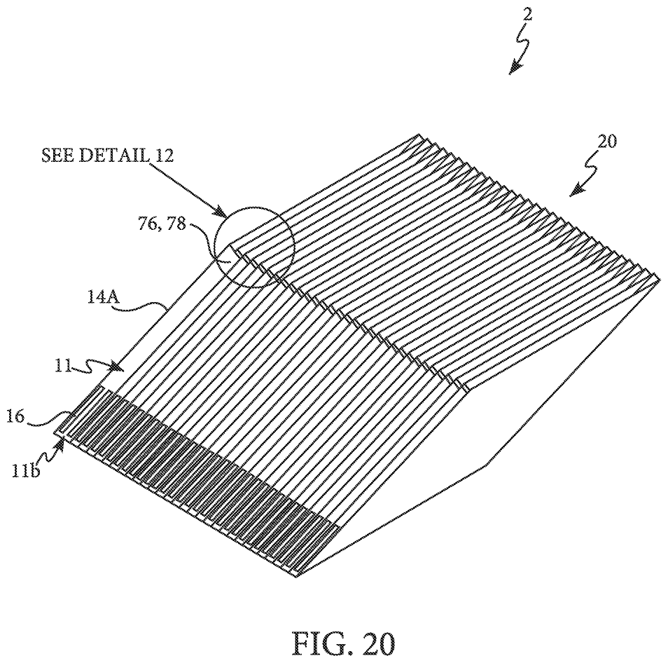

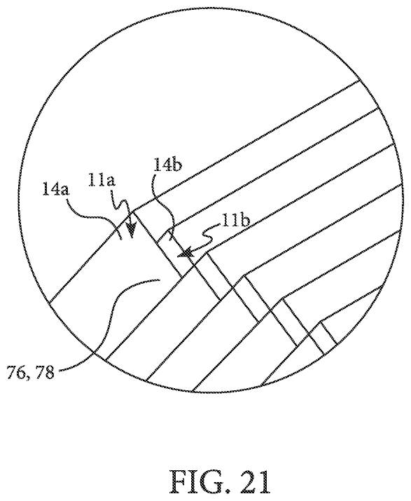

Referring to FIGS. 20 and 21, another embodiment of a water treatment system 2 including a clarifier 20 having a plurality of parallel inclined modules 11a, 11b having planar inclined sheets including the flexible polymeric material is shown. The water treatment system 2 of FIGS. 20 and 21 may include the cover assembly 100 of FIGS. 1-9. In this particular embodiment, the support 14a of a first module 11a may include an overlap material that overlaps the support 14b of the adjacent second module 10b so as to form an overlap 76. The overlap 76 may include a weld 78 or other fastening arrangement (sewing, chemical bonding, gluing, and the like) such that the overlap material of the first support 14a is fixed to the second support 14b to fix the first module 10a relative to the second module 11b. Other arrangements for fixing one module to an adjacent module are also within the scope of the invention.

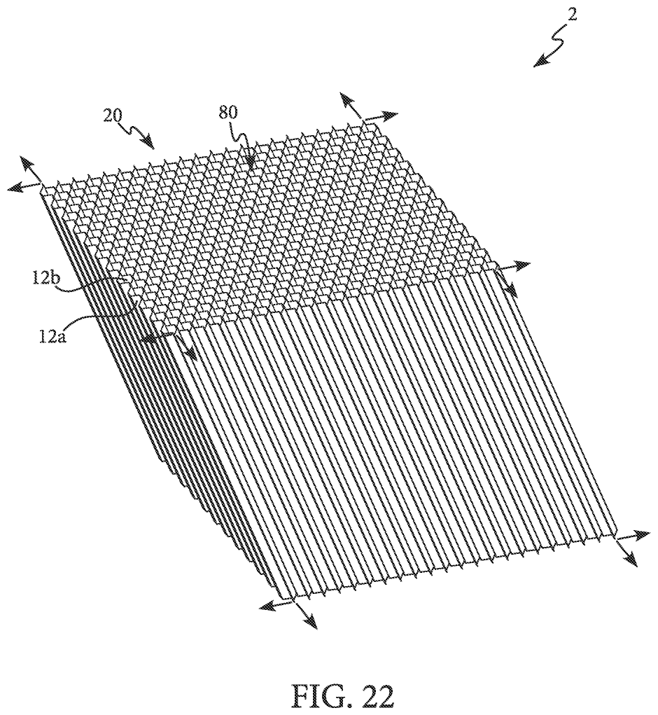

Referring to FIG. 22, a water treatment system 2 having a tube clarifier 20 is shown. The water treatment system 2 of FIG. 22 may include the cover assembly 100 of FIGS. 1-9. The tube clarifier 20 may include a plurality of inclined tubes 80 formed from a flexible material. The flexible material may define a cavity so as to form the tube 80. The tube may have a cross-section of any suitable shape, such as a circle, oval, square, rectangle, or honeycomb. The flexible material may include any of the previously-described flexible materials of the sheets. The flexible material may have a hydrophobic surface a previously described and may have a surface roughness as previously described. The plurality of tubes may be fixed relative to one another. In one example, a first tube may be fastened to an adjacent second tube, such as by welding, gluing, weaving, or the like. The plurality of inclined tubes may form an angle with the ground of from 10° to 90°, such as from 20° to 80°, from 35° to 70°, from 40° to 60°, from 45° to 65°, or from 45° to 55°.

With continued reference to FIG. 22, the plurality of inclined tubes 80 of the tube clarifier 20 may be tensioned in any number of directions such that the tubular structure of the clarifier 20 is formed, as shown in FIG. 22. The tension may be provided by cables fixed to basin walls or via an external frame.

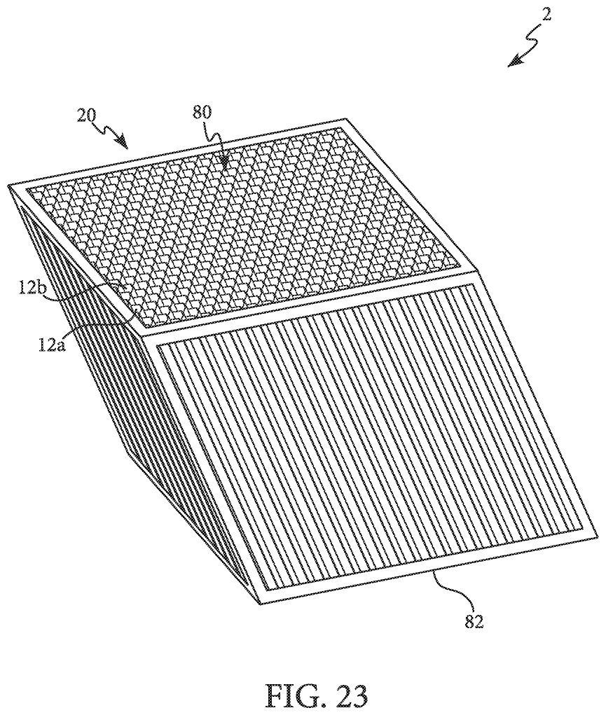

Referring to FIG. 23, the tube clarifier 20 from FIG. 22 is shown, except in this embodiment, a frame 82 is included to support the clarifier 20. The frame 82 may span the edges of the tube clarifier 20 so as to give the tubular clarifier 20 its structure. Other arrangements for supporting the tube clarifier 20 are within the scope of the invention.

Although non-limiting embodiments have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A water treatment system comprising:
a basin;
a clarifier disposed in the basin;
a pair of collection troughs each arranged at least partially above the clarifier; and
at least one cover assembly comprising:
a frame coupled to the pair of collection troughs, and
a cover coupled to the frame, the cover being made of a nylon mesh material.

2. The water treatment system according to claim 1, wherein the frame is pivotably coupled to the pair of collection troughs and is configured to pivot between an open position and a closed position.

3. The water treatment system according to claim 1, wherein the frame comprises a rectangular-shaped body portion and a pair of flanges, each of the pair of flanges extending outwardly from an opposing side of the body portion and being configured to rest on and engage a corresponding one of the pair of collection troughs.

4. The water treatment system according to claim 1, wherein the cover weighs less than 14 pounds.

5. The water treatment system according to claim 1, wherein the cover comprises a logo on a surface of the cover.

6. The water treatment system according to claim 1, wherein the at least one cover assembly is a plurality of cover assemblies.

7. The waste treatment system according to claim 1, wherein the clarifier comprises a plurality of planar inclined sheets comprising a flexible polymeric material.

8. The water treatment system according to claim 7, wherein the flexible polymeric material comprises polyester, polyethylene, polypropylene, polytetrafluoroethylene (PTFE), and/or polyvinyl chloride (PVC).

9. The water treatment system according to claim 7, wherein the clarifier comprises a plurality of vertically-oriented supports, wherein a sheet of the plurality of planar inclined sheets is tensioned between the plurality of vertically-oriented supports.

10. The water treatment system according to claim 9, wherein a vertically-oriented support of the plurality of vertically-oriented supports comprises an inlet opening configured to allow liquid to flow therethrough.

11. The water treatment system according to claim 7, wherein the plurality of planar inclined sheets are arranged parallel to one another, and each sheet of the plurality of planar inclined sheets is tensioned between a plurality of vertically-oriented supports.

12. The water treatment system according to claim 11, wherein vertically-oriented supports tensioning a first sheet of the plurality of planar inclined sheets interlock with adjacent vertically-oriented supports tensioning a second sheet of the plurality of planar inclined sheets.

13. The water treatment system according to claim 1, further comprising a pair of buoyant members that are configured to support each collection trough of the pair of collection troughs.

14. A method for treating water, comprising:
providing the water treatment system according to claim 1;
flowing water to the clarifier; and
collecting clarified water and/or waste material separated from the water by the clarifier.
